(19) United States
(12) Patent Application Publication
(10) Pub. No.: US 2020/0393851 A1
(43) Pub. Date: Dec. 17, 2020

(54) MULTI-ROTOR HIGH PERFORMANCE DESCENT METHOD AND SYSTEM

(71) Applicant: Bell Textron Inc., Fort Worth, TX (US)

(72) Inventors: Sung Kyun KIM, Bedford, TX (US); Michael Reaugh SMITH, Colleyville, TX (US)

(73) Assignee: Bell Textron Inc., Fort Worth, TX (US)

(21) Appl. No.: 16/439,482

(22) Filed: Jun. 12, 2019

(51) Int. Cl. G05D 1/04; B64C 29/02; B64C 27/52

(52) U.S. Cl. CPC G05D 1/042; B64C 27/52; B64C 29/02

(57) ABSTRACT

A high-performance descent system for a multi-rotor aircraft includes a flight control computer comprising a processor, a propulsion system communicatively coupled to the flight control computer and configured to allow a direction of thrust relative to a vertical z-axis to be selected by the flight control computer. The processor is operable to implement a method including preparing the multi-rotor aircraft for a high-performance descent, instructing, via a flight control system, a proprotor to reduce an amount of vertical thrust produced by the proprotor by tilting the proprotor away from a vertical axis, and reducing an altitude of the multi-rotor aircraft.

### TECHNICAL FIELD

The present disclosure relates generally to multi-rotor aircraft, and more particularly, but not by way of limitation to systems and methods for high-performance descent of multi-rotor aircraft.

### BACKGROUND

This section provides background information to facilitate a better understanding of the various aspects of the disclosure. It should be understood that the statements in this section of this document are to be read in this light, and not as admissions of prior art.

Some rotor aircraft use rotor systems having rotors of fixed pitch. Thrust provided by fixed-pitch rotor systems is controlled by changing rotor speed. For example, to produce more thrust, rotor system speed is increased. To produce less thrust, rotor system speed is decreased. In order to maintain stable flight characteristics, fixed-pitch rotor systems must maintain a minimum operating speed. If the speed of the rotor system falls below the minimum operating speed, control authority from the rotor systems can become insufficient and the aircraft becomes unstable. As a result of the necessary minimum operating speed, there exists a minimum amount of thrust that the aircraft is capable of generating during flight. The minimum amount of thrust generated affects a maximum descent rate for the aircraft. In some situations, the minimum amount of thrust generated can make it so that the aircraft is unable to descend. For example, updrafts, such as warm air streams or thermals, can overcome the rate of descent of the aircraft and prevent the aircraft from losing altitude. In some situations, aircraft have been lost because the aircraft was unable to descend to the ground to land before running out of fuel or battery.

An additional consideration regarding the maximum descent rate is a phenomenon known as the vortex ring state (VRS). The VRS is a known phenomenon that can affect VTOL aircraft. In short, a VTOL aircraft that descends too quickly can suddenly experience a loss in lift generated by the rotor system. The sudden loss in lift is the result of a vortex ring system engulfing the rotor system, which essentially causes the rotor system to stall. VRS can be quite dangerous and, if not handled properly, can result in crashing the aircraft.

### SUMMARY

This summary is provided to introduce a selection of concepts that are further described below in the detailed description. This summary is not intended to identify key or essential features of the claimed subject matter, nor is it to be used as an aid in limiting the scope of the claimed subject matter.

An illustrative high-performance descent method for a multi-rotor aircraft includes preparing the multi-rotor aircraft for a high-performance descent, instructing, via a flight control system, a first proprotor to tilt, tilting the proprotor away from a vertical axis; and wherein, responsive to the tilting, an altitude of the multi-rotor aircraft is reduced.

An illustrative high-performance descent system for a multi-rotor aircraft includes a flight control computer comprising a processor, a propulsion system communicatively coupled to the flight control computer and configured to allow a direction of thrust relative to a vertical z-axis to be selected by the flight control computer. The processor is operable to implement a method including preparing the multi-rotor aircraft for a high-performance descent, instructing, via a flight control system, a proprotor to reduce an amount of vertical thrust produced by the proprotor by tilting the proprotor away from a vertical axis, and reducing an altitude of the multi-rotor aircraft.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIGS. 1A-1C illustrate a multi-rotor aircraft according to aspects of the disclosure;

FIG. 2 illustrates an articulating rotor according to aspects of the disclosure;

FIG. 3 is a flow chart illustrating a method of high-performance descent;

FIGS. 4A-4D illustrate thrust vectors for high-performance descent; and

FIG. 5 is a schematic diagram of a general-purpose processor (e.g. electronic controller or computer) system suitable for implementing aspects of the disclosure.

### DETAILED DESCRIPTION

Various embodiments will now be described more fully with reference to the accompanying drawings. The disclosure may, however, be embodied in many different forms and should not be construed as limited to the embodiments set forth herein.

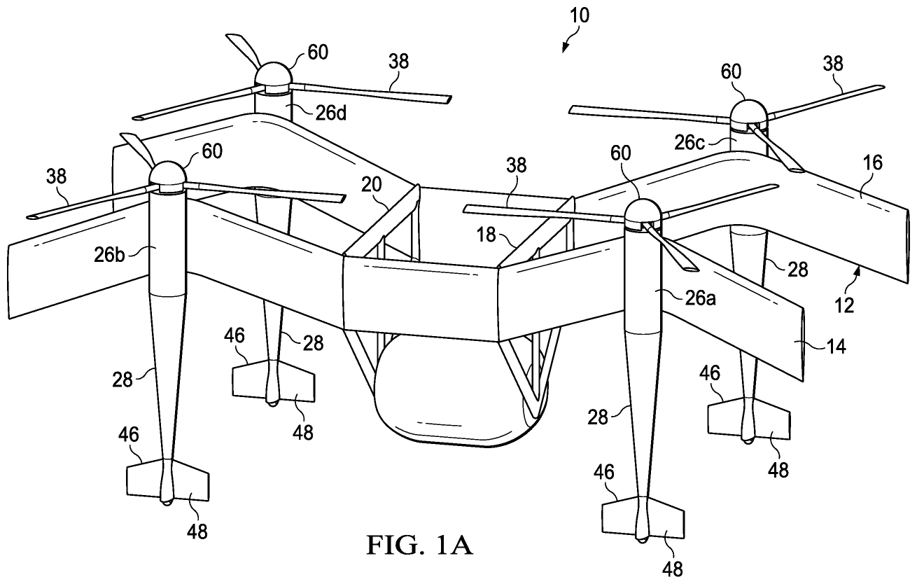

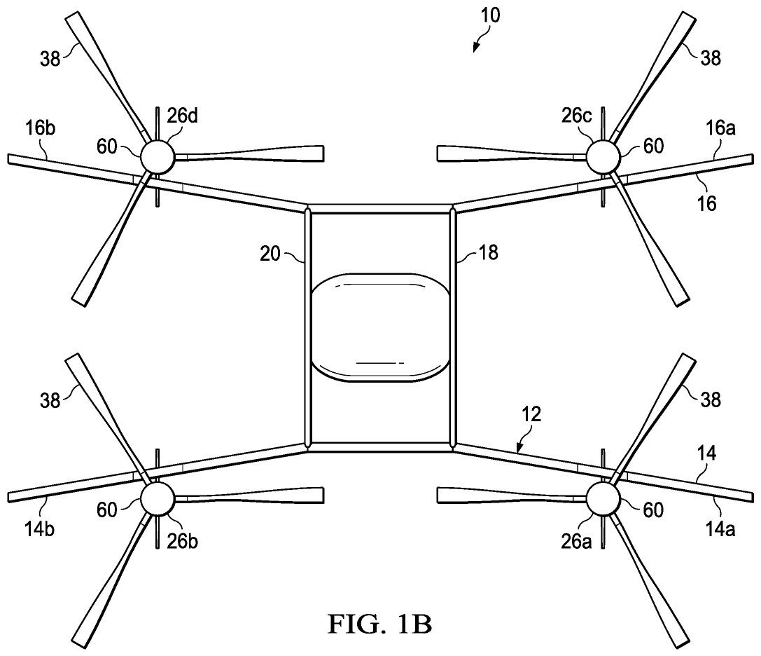

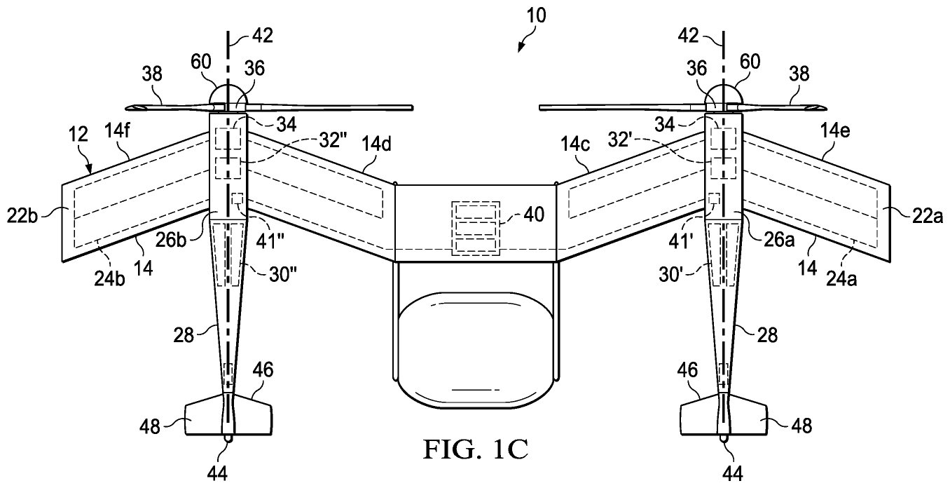

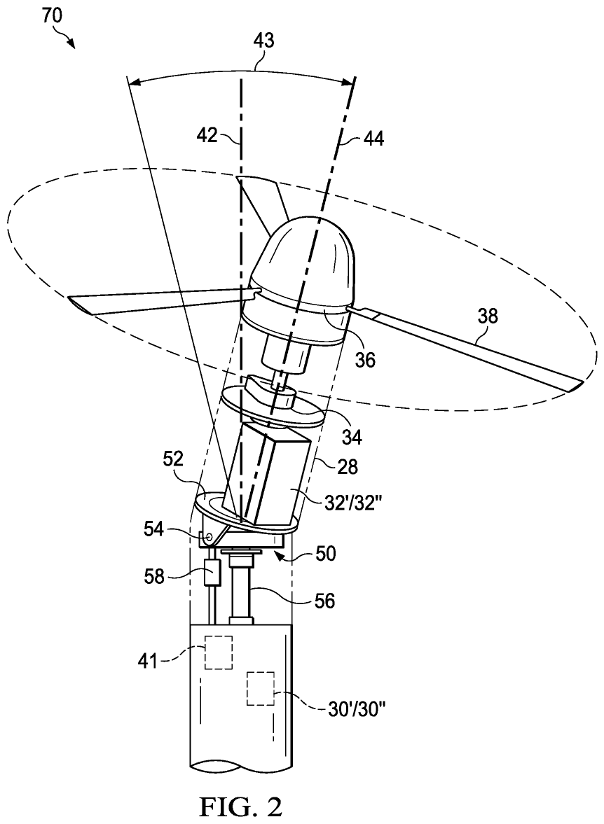

Unlike fixed-wing aircraft, vertical takeoff and landing (VTOL) aircraft do not require runways. Instead, VTOL aircraft are capable of taking off, hovering, and landing vertically. Drones are one example of a VTOL aircraft. VTOL drones typically have multiple rotors that provide lift to allow the aircraft to fly. A wide variety of drones exist. Exemplary drones include, for example, traditional multi-rotor aircraft (e.g., aircraft having two or more rotor systems that are capable of VTOL and translating horizontally similar to a helicopter) and tail-sitter aircraft (e.g., see FIGS. 1-2 below illustrating a tail-sitter aircraft that is capable of VTOL and can also transition between helicopter and airplane modes).

The descent-related problems identified above (e.g., inability to descend and VRS) can be mitigated using the systems and methods discussed herein. For example, the maximum descent rate of a multi-rotor aircraft can be increased by changing thrust vectors of the rotor systems of the multi-rotor aircraft. Changing the thrust vectors of the rotor systems changes the amount of vertical thrust generated by the aircraft, but maintains the minimum operating speed of the rotor systems to prevent the aircraft from losing differential control authority and becoming unstable. The minimum operating speed is the operating speed at which the aircraft can exhibit stable and predictable flying characteristics while closely following reference states (rates, attitudes, accelerations, etc.) without extra effort from either the pilot or the computer. In some aspects, the minimum operating speed might be limited in order to avoid resonance with a structural or rotor system natural frequency. Changing the thrust vectors of the rotor systems not only allows for a faster maximum descent rate, but further reduces the likelihood that the aircraft will suffer from VRS related problems because air from the rotor systems can be directed horizontally away from the aircraft.

Referring to FIGS. 1A-1C, various views of a multi-rotor aircraft 10 are depicted according to aspects of the disclosure. Aircraft 10 is a tail-sitter aircraft capable of taking off from and landing on the tail assemblies of aircraft 10. While in the air, aircraft 10 can transition to forward flight. Aircraft 10 includes an airframe 12 having wings 14, 16 that have an airfoil cross-section that generates lift responsive to the forward airspeed of aircraft 10. Wings 14, 16 may be formed as single members or may be formed from multiple wing sections. The outer skins for wings 14, 16 are preferably formed from high strength and lightweight materials such as fiberglass fabric, carbon fabric, fiberglass tape, carbon tape and combinations thereof that may be formed by curing together a plurality of material layers. Aircraft 10 is discussed herein for illustrative purposes. It will be appreciated by those having skill in the art that the methodologies discussed herein apply to various other multi-rotor aircrafts, including tiltrotors and traditional multi-rotor aircraft (e.g., quad-copters and the like).

Truss structures or pylons 18, 20 extend generally perpendicularly between wings 14, 16. Pylons 18, 20 are preferably formed from high strength and lightweight materials such as fiberglass fabric, carbon fabric, fiberglass tape, carbon tape and combinations thereof that may be formed by curing together a plurality of material layers. Pylons 18, 20 and/or wings 14, 16 may support various components of aircraft 10, such as flight control system 40. Wings 14, 16 and pylons 18, 20 are securably attached together at the respective intersections by bolting, bonding and/or other suitable technique such that airframe 12 becomes a unitary member. Wings 14, 16 may include central passageways operable to contain energy sources and communication lines.

Aircraft 10 includes a plurality of propulsion systems 26a-26d attached to airframe 12. Each propulsion system 26a-26d is independently controllable. It will be appreciated that aircraft 10 could be configured with any number of propulsion systems 26, including two, three, five, six, eight, twelve, sixteen or other numbers of propulsion systems. Each propulsion system 26a-26d may include a nacelle 28 that houses various components, such as a power source, an engine or motor, a drive system, a rotor hub, actuators and an electronics node including, for example, controllers, sensors and communications elements as well as other components suitable for use in the operation of a propulsion system (best seen in FIGS. 1C and 2). Each propulsion system 26a-26d includes a tail assembly 46 having an active aerosurface 48 (best seen in FIGS. 1A and 1C). In addition, each propulsion system 26a-26d has a rotor assembly including 60 a rotor hub 36 having a plurality of grips such as spindle grips and a proprotor 38 depicted as having three rotor blades, each of which is coupled to one of the spindle grips of the respective rotor hub such that the rotor blades are operable to rotate with the spindle grips about respective pitch change axes, as discussed herein.

In some aspects, aircraft 10 can be powered via a liquid fuel, wherein energy is provided to each of the propulsion assemblies from combustion of the liquid fuel. For example, in this configuration, each of the propulsion systems 26a-26d may be represented by propulsion system 26a of FIG. 1C. As illustrated, propulsion system 26a includes a nacelle 28a, one or more fuel tanks 30′, an internal combustion (IC) engine 32′, a drive system 34, rotor hub 36, a proprotor 38 and an electronics node 41′. In the liquid fuel flight mode, the fuel tanks of the propulsion assemblies may be connected to the fluid distribution network of the airframe and serve as feeder tanks for the IC engines. Alternatively, the liquid fuel system may be a distributed system wherein liquid fuel for each propulsion system is fully self-contained within the fuel tanks positioned within the nacelles, in which case, the wet wing system described above may not be required. The IC engines may be powered by gasoline, jet fuel, diesel or other suitable liquid fuel. The IC engines may be rotary engines such as dual rotor or tri rotor engines or other high power-to-weight ratio engines. The drive systems may include multistage transmissions operable for reduction drive such that optimum engine rotation speed and optimum proprotor rotation speed are enabled. The drive systems may utilize high-grade roller chains, spur and bevel gears, v-belts, high strength synchronous belts or the like. As one example, the drive system may be a two-stage cogged belt reducing transmission including a 3 to 1 reduction in combination with a 2 to 1 reduction resulting in a 6 to 1 reduction between the engine and the rotor hub.

In some aspects, aircraft 10 can be powered by electricity, wherein energy is provided to each of the propulsion systems 26a-26d from an electric power source. For example, in this configuration, each of the propulsion assemblies may be represented by propulsion system 26b of FIG. 1C. As illustrated, propulsion system 26b includes a nacelle 28, one or more batteries 30″, an electric motor 32″, drive system 34, rotor hub 36, a proprotor 38, and electronics node 41″. In the electric flight mode, the electric motors of each propulsion system are preferably operated responsive to electrical energy from the battery or batteries disposed with that nacelle, thereby forming a distributed electrical system. Alternatively or additionally, electrical power may be supplied to the electric motors and/or the batteries disposed with the nacelles from the energy sources, such as energy sources 22a, 22b, carried by airframe 12 via the communication lines, such as communication lines 24a, 24b.

The rotor assemblies of each propulsion system 26a-26d are preferably lightweight, rigid members that may optionally include swashyoke mechanisms operable for collective pitch control and thrust vectoring. Proprotors 38 include a plurality of proprotor blades that are securably attached to spindle grips of the respective rotor hub. In some aspects, the proprotor blades are operable for collective pitch control and may additionally be operable for cyclic pitch control. In some aspects, the pitch of the proprotor blades is fixed, in which case thrust is determined by changes in the rotational velocity of the proprotors. In the illustrated embodiment, the rotor hubs have a tilting degree of freedom to enable thrust vectoring. FIG. 2 illustrates a tilting rotor hub configuration. Additional tilting rotor hub configurations are illustrated in U.S. Pat. No. 10,220,944 and U.S. Patent Pub. Nos. 2019/0031331 and 2018/0002026, each of which is incorporated in its entirety as if fully set forth herein.

To accommodate the tilting degree of freedom of the rotor hubs, wings 14, 16 have a unique swept wing design, which is referred to herein as an M-wing design. For example, as best seen in FIG. 1C, wing 14 has swept forward portions 14c, 14d and swept back portions 14e, 14f. Propulsion system 26a is coupled to a wing stanchion positioned between swept forward portion 14c and swept back portion 14e. Likewise, propulsion system 26b is coupled to a wing stanchion positioned between swept forward portion 14d and swept back portion 14f. Wing 16 has a similar M-wing design with propulsion systems 26c, 26d similarly coupled to wing stanchions positioned between swept forward and swept back portions. In this configuration, each rotor hub is operable to pivot about a mast axis 42 to control the direction of the thrust vector while avoiding any interference between any of proprotors 38 and wings 14, 16. The maximum angle of the thrust vector depends in part upon mechanical and geometrical limitations. In some aspects, the maximum angle of the thrust vector may be between about 10 degrees and about 45 degrees. In some aspects, the maximum angle of the thrust vector may be between about 15 degrees and about 25 degrees relative to the vertical axis. In some aspects, the maximum angle of the thrust vector may be about 20 degrees relative to the vertical axis. In aspects having a maximum thrust vector angle of 20 degrees, the thrust vector may be resolved to any position within a 20-degree cone swung about the mast centerline axis. Notably, using a 20-degree thrust vector yields a horizontal component of thrust that is about 34 percent of total thrust.

Even though the propulsion assemblies of the present disclosure have been described as having certain nacelles, power sources, engines, drive systems, rotor hubs, proprotors and tail assemblies, it is to be understood by those having ordinary skill in the art that propulsion assemblies having other components or combinations of components suitable for use in a versatile propulsion system are also possible and are considered to be within the scope of the present disclosure.

Each tail assembly 46 includes an active aerosurface 48 that is controlled by an active aerosurface control module of a flight control system 40. During various flight operations, active aerosurfaces 48 of propulsion systems 26a-26d may operate as vertical stabilizers, horizontal stabilizers, rudders and/or elevators to selectively provide pitch control and yaw control to aircraft 10.

Flight control system 40 of aircraft 10, such as a digital flight control system, may be located within a central passageway of wing 14 (e.g., see FIG. 1C). Flight control system 40 may be a triply redundant flight control system including three independent flight control computers. Use of triply redundant flight control system 40 having redundant components improves the overall safety and reliability of aircraft 10 in the event of a failure in flight control system 40. Flight control system 40 preferably includes non-transitory computer readable storage media including a set of computer instructions executable by one or more processors for controlling the operation of the versatile propulsion system. Flight control system 40 may be implemented on one or more general-purpose computers, special purpose computers or other machines with memory and processing capability. For example, flight control system 40 may include one or more memory storage modules including, but is not limited to, internal storage memory such as random access memory, non-volatile memory such as read only memory, removable memory such as magnetic storage memory, optical storage, solid-state storage memory or other suitable memory storage entity. Flight control system 40 may be a microprocessor-based system operable to execute program code in the form of machine-executable instructions. In addition, flight control system 40 may be selectively connectable to other computer systems via a proprietary encrypted network, a public encrypted network, the Internet or other suitable communication network that may include both wired and wireless connections.

Flight control system 40 communicates with electronics nodes 41 of each propulsion system 26a-26d, respectively. Flight control system 40 receives sensor data from and sends flight command information to each electronics node 41 of each propulsion system 26a-26d such that each propulsion system 26a-26d may be individually and independently controlled and operated. In both manned and unmanned missions, flight control system 40 may autonomously control some or all aspects of flight operation for aircraft 10. Flight control system 40 is also operable to communicate with remote systems, such as a transportation services provider system via a wireless communications protocol. The remote system may be operable to receive flight data from and provide commands to flight control system 40 to enable remote flight control over some or all aspects of flight operation for aircraft 10, in both manned and unmanned missions.

Flight control system 40 is operable to independently control each propulsion system 26a-26d. For example, flight control system 40 can control collective pitch (when aircraft 10 is so equipped) and adjust the thrust vector of each propulsion system 26a-26d, which can be beneficial in stabilizing aircraft 10 during vertical takeoff, vertical landing and hover. Adjusting the thrust vector each propulsion system 26a-26d also enables aircraft 10 to perform a high-performance or rapid descent maneuver. The high-performance descent maneuver will be discussed in more detail below.

As discussed herein, flight control system 40 is operable to independently control each of the propulsion systems 26 including tilting each rotor assembly 60. For each propulsion system 26, flight control system 40 is operable to tilt rotor assembly 60 relative to mast axis 42. When propulsion systems 26a-26d are being operated and rotor assemblies 60 are tilted relative to mast axis 42, the thrust vectors generated by rotor assemblies 60 have a vertical component and a horizontal component. When rotor assemblies 60 are not tilted, the horizontal component of thrust for each rotor assembly 60 is zero.

FIG. 2 illustrates an articulating proprotor 70 for use with propulsion systems 26a-26d according to aspects of the disclosure. Flight control system 40 is operable to individually and independently control the thrust vector of articulating proprotor 70. Propulsion systems 26a-26d may be configured for combustion operation or electric operation. For combustion operation, each propulsion system 26a-26d includes one or more fuel tanks 30′, IC engine 32′, a drive system 34, a rotor hub 36, a proprotor 38, and an electronics node 41. For electric operation, each propulsion system 26a-26d includes one or more batteries 30″, electric motor 32″, a drive system 34, a rotor hub 36, a proprotor 38, and an electronics node 41.

Each propulsion system 26a-26d includes a thrust vectoring system depicted as a dual actuated thrust vectoring control assembly 50. As illustrated, IC engine 32′ or electric motor 32″, drive system 34, rotor hub 36 and proprotor 38 are mounted to a pivotable plate 52 operable to pivot about a pivot axis defined by pin 54. In some aspects, pivotable plate 52 is also operable to rotate about mast axis 42 to control the azimuth within the thrust vectoring system. Rotation of pivotable plate 52 is accomplished with an electromechanical rotary actuator 56, but other suitable rotary actuator could alternatively be used. The elevation of pivotable plate 52 is controlled with a linear actuator 58 that pulls and/or pushes pivotable plate 52 about the pivot axis. As illustrated in FIG. 2, a maximum pitch angle 43 of a thrust vector 44 is approximately 20 degrees from mast axis 42 (total range of motion of about 40 degrees). Accordingly, it should be understood by those skilled in the art that the thrust vector may be resolved to any position within the 20-degree cone swung about mast axis 42. The use of a 20-degree pitch angle yields a horizontal component of thrust that is about 34 percent of the total thrust and a vertical component that is about 66 percent of the total thrust. The 34 percent reduction of vertical thrust allows aircraft 10 to descend more rapidly to perform a high-performance descent while at the same time maintaining the minimum operating speed of the proprotor.

The thrust vectoring of each of the propulsion systems 26a-26d is independently controlled by flight control system 40. In some aspects, flight control system 40 is operated autonomously. In some aspects, flight control system 40 may be controlled by a pilot onboard the aircraft or remote from the aircraft. In addition to allowing the aircraft to perform a high-performance descent, changing the thrust vector of propulsion systems 26a-26d enables differential yaw control during hover, as well as an unlimited combination of differential horizontal thrust coupled with net horizontal thrust to allow positioning over a stationary target, for example when crosswinds are present. Even though a particular thrust vectoring system having a particular maximum pitch angle has been depicted and described, it will be understood by those skilled in the art that other thrust vectoring systems, such as a gimbaling system or a teetering rotor that has the ability to tilt the thrust axis relative to a mast of the rotorcraft, having other maximum pitch angles, either greater than or less than 20 degrees, may alternatively be used on flying frames of the present disclosure. Additional tilting rotor hub configurations are illustrated in U.S. Pat. No. 10,220,944 and U.S. Patent Pub. Nos. 2019/0031331 and 2018/0002026, each of which is incorporated in its entirety as if fully set forth herein.

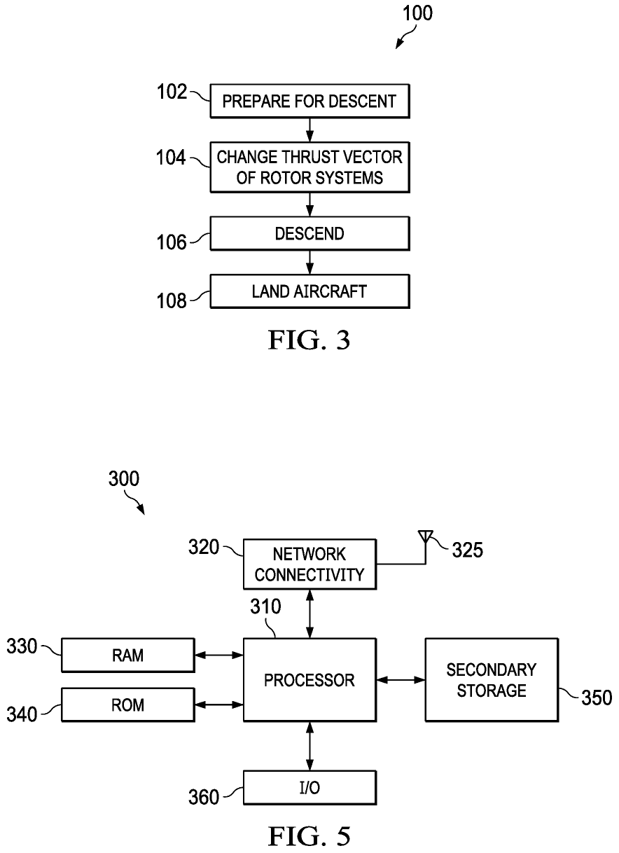

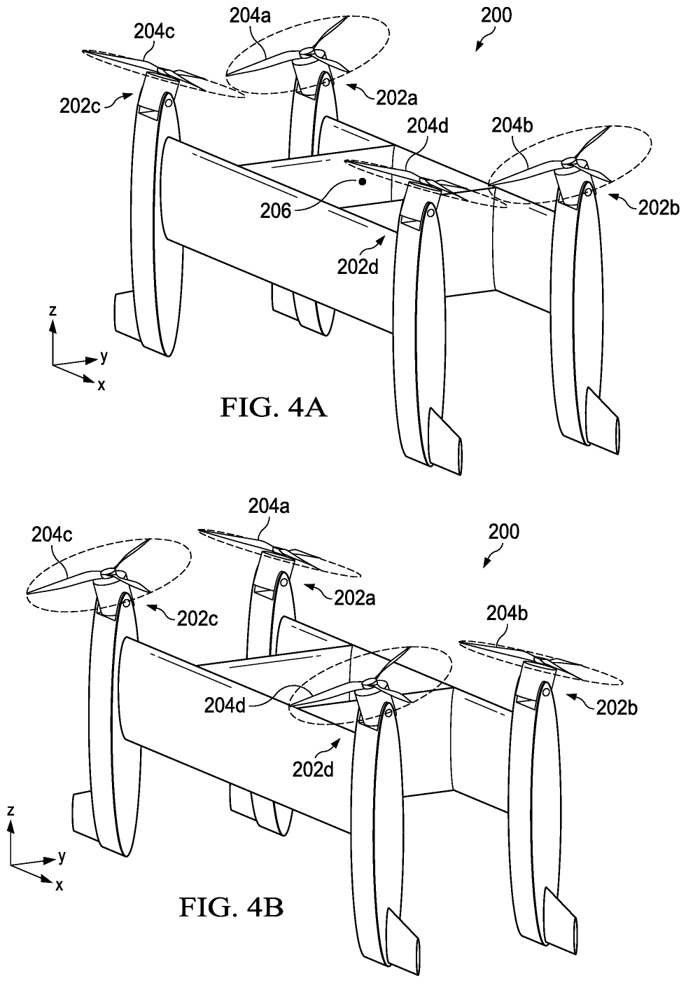

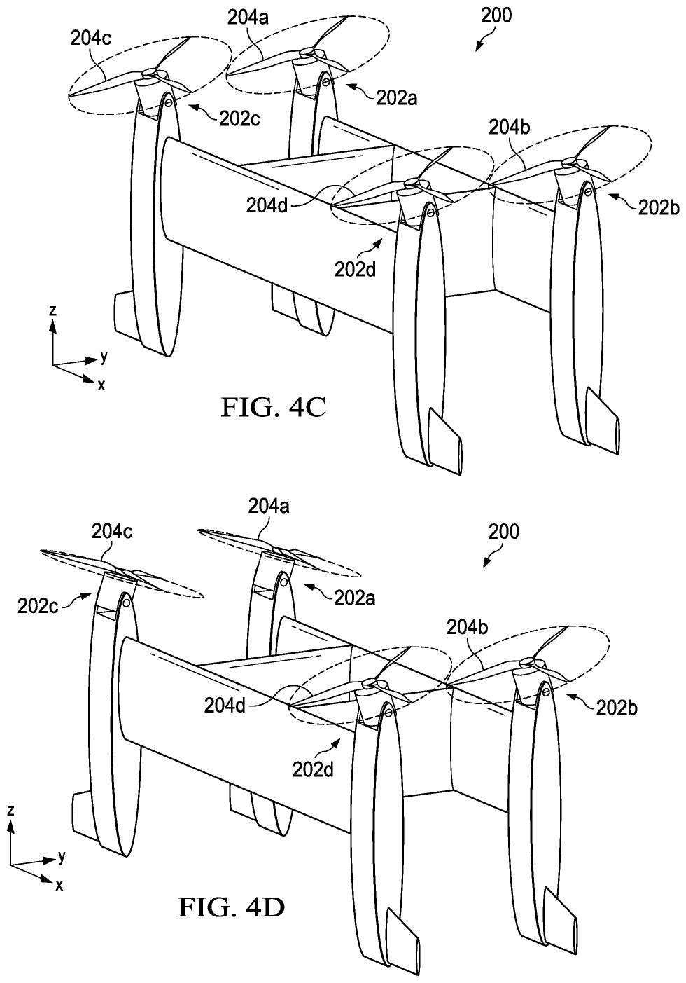

FIG. 3 is a flow chart illustrating a method 100 for high-performance decent by a multi-rotor aircraft. By way of illustration, FIG. 3 is discussed with reference to a multi-rotor aircraft 200 of FIG. 4. Aircraft 200 includes rotor hubs 202a-202d, each of which can be tilted relative to the vertical z-axis. It will be understood by those having skill in the art that method 100 also applies to multi-rotor aircraft other than aircraft 200 (e.g., aircraft 10 of FIGS. 1A-1C). In some aspects, method 100 is carried out autonomously or automatically. For example, method 100 may be implemented by flight control system 40 automatically upon initiating a landing sequence. In some aspects, method 100 may be carried out by a pilot. The pilot may be on board the aircraft or may be remote from the aircraft.

Method 100 begins at step 102. In step 102, aircraft 200 prepares for a high-performance descent. Preparations for high-performance descent can include transitioning to helicopter mode if aircraft 200 was flying in airplane mode. In some aspects, preparations include reducing a speed of the proprotors of aircraft 200, for example to a minimum operating speed. The minimum operating speed is the slowest speed at which control of aircraft 200 can be safely maintained. The minimum operating speed could be the speed where the aircraft can exhibit stable and predictable flying characteristics while closely following reference states (rates, attitudes, accelerations, etc.) without extra effort from either pilot or the computer. In addition, a minimum operating speed might be limited by avoiding resonance with a structural or rotor system natural frequency. Method 100 then proceeds to step 104.

In step 104, vertical thrust generated by aircraft 200 is reduced. Vertical thrust is reduced by altering a thrust vector of one or more of proprotors 204a-204d. In some aspects, the thrust vector of proprotors 204a-204d may be altered by tilting rotor hubs 202a-202d away from the z-axis, which reduces a vertical component of the thrust vectors (i.e., the component parallel to the z-axis) of proprotors 204a-204d. FIGS. 4A-4D illustrate four different configurations of rotor hubs 202a-202d that reduce the vertical component of the thrust vectors of proprotors 204a-204d. It will be appreciated that the thrust vectors of proprotors 204a-204d can be altered in various ways. Tilting rotor hubs 202a-202d illustrates one such way and is not intended to be limiting.

The configurations of FIGS. 4A-4D may similarly be applied to other multi-rotor aircraft that have the tiltable rotor hubs/proprotors. The tilt of rotor hubs 202a-202d is controlled by a flight control system of aircraft 200 (e.g., similar to flight control system 40 of aircraft 10). FIGS. 4A and 4B illustrate configurations of aircraft 200 for which the thrust vectors of rotor hubs 202a-202d are horizontally balanced, FIG. 4C illustrates a configuration of aircraft 200 for which the thrust vectors of rotor hubs 202a-202d are not horizontally balanced, and FIG. 4D illustrates a configuration of aircraft 200 for which the thrust vectors of rotor hubs 202a-202d are horizontally balanced but not azimuthally balanced (i.e., yaw is induced). As used herein, the thrust vectors are horizontally balanced when the horizontal components of the thrust vectors cancel each other out. The thrust vectors are not horizontally balanced when the horizontal components of the thrust vectors do not cancel each other out.

Referring now to FIG. 4A, rotor hubs 202a and 202b are pivoted toward rotor hubs 202c and 202d, respectively. Similarly, rotor hubs 202c and 202d are pivoted toward rotor hubs 202a and 202b, respectively. Rotor hubs 202a and 202b generate negative horizontal thrust vectors in the direction of the y-axis and rotor hubs 202c and 202d generate positive horizontal thrust vectors in the direction of the y-axis. In FIG. 4A, the horizontal components of thrust of rotor hubs 202a-202d cancel each other out to horizontally balance the thrust vectors in the x-y plane. As oriented in FIG. 4A, the vertical component of the thrust vector of each tilted rotor hubs 202a-202d is reduced compared to the vertical component of rotor hubs 202a-202d when rotor hubs 202a-202d are not tilted, which reduces the amount of vertical thrust being generated by each rotor hub 202a-202d. As a result, aircraft 200 can perform a high-performance descent when configured as illustrated in FIG. 4A. When approaching the ground for landing, this configuration of the respective rotor hubs in FIG. 4A and 4B precludes generation of an up-spout and thereby enhances aircraft stability during descent and landing. An up-spout is produced by the interaction of two or more downward air streams that, once impacting the ground plane, turn radially. A portion of the radial airflow collides with other downward airstreams that in turn have turned radially. As these airstreams collide, they produce an up-spout which interferes with the aircraft's downward descent and landing.

The flight control system of aircraft 200 controls the amount of vertical thrust generated by rotor hubs 202a-202d by increasing the amount of tilt of rotor hubs 202a-202d. Vertical thrust decreases as tilt angle relative to the z-axis increases. Reducing the vertical thrust of rotor hubs 202a-202d allows aircraft 200 to perform a high-performance descent as aircraft 200 descends faster than a similar aircraft that cannot reduce vertical thrust by tilting its rotor hubs. Importantly, even though vertical thrust is reduced, the minimum operating speed of each rotor hub 202a-202d of aircraft 200 is maintained. An added benefit of tilting rotor hubs 202a-202d is that the air exhausted by the proprotors is directed away from aircraft 200 to reduce the likelihood of inducing the VRS phenomenon. Thus, unlike conventional multi-rotor aircraft, aircraft 200 can perform a high-performance descent.

FIG. 4B illustrates an additional configuration of aircraft 200 that is similar to FIG. 4A. However, in FIG. 4B, rotor hubs 202a and 202b are now tilted away from rotor hubs 202c and 202d and vice versa. The configuration of FIG. 4B is also horizontally balanced.

FIG. 4C illustrates an additional configuration of aircraft 200 in which rotor hubs 202a and 202b are pivoted toward rotor hubs 202c and 202d, respectively. Rotor hubs 202c and 202d are pivoted away from rotor hubs 202a and 202b, respectively. Rotor hubs 202a-202d generate negative horizontal thrust vectors in the direction of the y-axis. In FIG. 4C, the horizontal components of thrust do not cancel each other out and a horizontal thrust vector exists in the x-y plane in the negative y-direction. As oriented in FIG. 4C, the vertical component of the thrust vector of each of the tilted rotor hubs 202a-202d is reduced compared to vertical component of rotor hubs 202a-202d when rotor hubs 202a-202d are not tilted, thus reducing the amount of vertical thrust being generated by each rotor hub 202a-202d. In some aspects, it may be desirable to configure aircraft 200 in the orientation shown in FIG. 4C when a headwind is present. For example, in the presence of a head wind in the y-direction, orienting aircraft 200 in as shown in FIG. 4C allows for a high-performance descent while simultaneously mitigating some or all of the effect of the head wind. This configuration can also help aircraft 200 maintain position in windy conditions and provide guidance/stability during landing.

FIG. 4D illustrates an additional configuration of aircraft 200 in which rotor hubs 202a and 202c are tilted toward in a first direction, and rotor hubs 202b and 202d are tilted in a second direction that is opposite the first direction. The configuration of FIG. 4D similarly reduces the vertical component of the thrust vector for each rotor hub 202a-202d. However, the configuration of FIG. 4D induces yaw about the y-axis due to the cumulative effect of the horizontal thrust components of rotor hubs 202a-202d. In some aspects, it may be desirable to configure aircraft 200 in the orientation shown in FIG. 4D as the yawing action can help aircraft 200 descend through updrafts.

In addition to the configurations of FIGS. 4A-4D, it will be appreciated that rotor hubs 202a-202d can be tilted in a variety of combinations that fall within the spirit and scope of this disclosure. In general, tilting rotor hubs 202a-202d in any direction results in a decrease in the amount of vertical thrust generated. By way of example, other configurations could include orienting each rotor hub 202a-202d inward toward a common focal point 206 (common focal point 206 is illustrated in FIG. 4A) or outward away from common focal point 206. In other aspects, rotor hubs 202a and 202b could be tilted toward/away from a first common focal point and rotor hubs 202c and 202d could be tilted toward/away from a second common focal point (e.g., focal points disposed on opposite sides of common focal point 206). Either of these configurations would result in a horizontally balanced configuration. In other aspects, only some of the rotor hubs are tilted. For example, only a pair of rotor hubs 202a-202d may be tilted. For example, rotor hubs 202a, 202d may be tilted while rotor hubs 202b, 202c remain upright. It will also be appreciated that similar techniques could be used on aircraft having two or three rotor hubs or more than four rotor hubs.

After step 104, method 100 proceeds to step 106. In step 106, aircraft 200 performs a high-performance descent. High-performance descent is used herein to describe a descent in which at least the minimum operating speed of the proprotors is maintained, but the total vertical thrust generated by aircraft 200 is reduced compared to a configuration in which rotor hubs 202a-202d are not tilted. Tilting rotor hubs 202a-202d to reduce the total vertical thrust of aircraft 200 allows aircraft 200 to descend faster than if rotor hubs 202a-202d were not tilted.

In step 108, aircraft 200 lands. In some aspects, step 108 is optional. For example, it may be desirable for aircraft 200 to make a high-performance descent maneuver to a lower altitude without landing. For example, to avoid being detected by radar or to evade an oncoming aircraft while in VTOL mode, aircraft 200 may need to make a rapid descent to drop its altitude. Aircraft 200 can make such a descent utilizing step 102-106 discussed above. After performing the high-performance descent, each rotor hub 202a-202d may be returned to its non-tilted position to resuming normal flight. After landing in step 108, method 100 ends.

Referring now to FIG. 5, a schematic diagram of a general-purpose processor (e.g. electronic controller or computer) system 300 suitable for implementing the aspects of this disclosure is shown. System 300 includes processing component and/or processor 310 suitable for implementing one or more aspects disclosed herein. In some aspects, flight control system 40 and/or other electronic systems of aircraft 10 and flight control system of aircraft 200 may include one or more systems 300. In addition to processor 310 (which may be referred to as a central processor unit or CPU), system 300 can include network connectivity devices 320, random access memory (RAM) 330, read only memory (ROM) 340, secondary storage 350, and input/output (I/O) devices 360. In some cases, some of these components may not be present or may be combined in various combinations with one another or with other components not shown. These components might be located in a single physical entity or in more than one physical entity. Any actions described herein as being taken by the processor 310 might be taken by the processor 310 alone or by the processor 310 in conjunction with one or more components shown or not shown in the system 300. It will be appreciated that the data described herein can be stored in memory and/or in one or more databases.

Processor 310 executes instructions, codes, computer programs, or scripts that it might access from the network connectivity devices 320, RAM 330, ROM 340, or secondary storage 350 (which might include various disk-based systems such as hard disk, floppy disk, optical disk, or other drive). While only one processor 310 is shown, multiple processors 310 may be present. Thus, while instructions may be discussed as being executed by processor 310, the instructions may be executed simultaneously, serially, or otherwise by one or multiple processors 310. Processor 310 may be implemented as one or more CPU chips and/or application specific integrated chips (ASICs).

The network connectivity devices 320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 320 may enable processor 310 to communicate with the Internet or one or more telecommunications networks or other networks from which processor 310 might receive information or to which the processor 310 might output information.

The network connectivity devices 320 might also include one or more transceiver components 325 capable of transmitting and/or receiving data wirelessly in the form of electromagnetic waves, such as radio frequency signals or microwave frequency signals. Alternatively, the data may propagate in or on the surface of electrical conductors, in coaxial cables, in waveguides, in optical media such as optical fiber, or in other media. Transceiver component 325 might include separate receiving and transmitting units or a single transceiver. Information transmitted or received by transceiver 325 may include data that has been processed by processor 310 or instructions that are to be executed by processor 310. Such information may be received from and outputted to a network in the form, for example, of a computer data baseband signal or signal embodied in a carrier wave. The data may be ordered according to different sequences as may be desirable for either processing or generating the data or transmitting or receiving the data. The baseband signal, the signal embedded in the carrier wave, or other types of signals currently used or hereafter developed may be referred to as the transmission medium and may be generated according to several methods well known to one skilled in the art.

RAM 330 might be used to store volatile data and perhaps to store instructions that are executed by processor 310. ROM 340 is a non-volatile memory device that typically has a smaller memory capacity than the memory capacity of the secondary storage 350. ROM 340 might be used to store instructions and perhaps data that are read during execution of the instructions. Access to both RAM 330 and ROM 340 is typically faster than to secondary storage 350. Secondary storage 350 is typically comprised of one or more disk drives or tape drives and might be used for non-volatile storage of data or as an over-flow data storage device if RAM 330 is not large enough to hold all working data. Secondary storage 350 may be used to store programs or instructions that are loaded into RAM 330 when such programs are selected for execution or information is needed.

I/O devices 360 may include liquid crystal displays (LCDs), touchscreen displays, keyboards, keypads, switches, dials, mice, track balls, voice recognizers, card readers, paper tape readers, printers, video monitors, transducers, sensors, or other well-known input or output devices. Also, transceiver 325 might be considered to be a component of I/O devices 360 instead of or in addition to being a component of the network connectivity devices 320. Some or all of the I/O devices 360 may be substantially similar to various components disclosed herein and/or may be components of any of flight control system 130 and/or other electronic systems of aircraft 10.

Depending on the embodiment, certain acts, events, or functions of any of the algorithms, methods, or processes described herein can be performed in a different sequence, can be added, merged, or left out altogether (e.g., not all described acts or events are necessary for the practice of the algorithms, methods, or processes). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The term “substantially” is defined as largely but not necessarily wholly what is specified (and includes what is specified; e.g., substantially 90 degrees includes 90 degreesand substantially parallel includes parallel), as understood by a person of ordinary skill in the art. In any disclosed embodiment, the terms “substantially,” “approximately,” “generally,” “generally in the range of,” and “about” may be substituted with “within [a percentage] of” what is specified, as understood by a person of ordinary skill in the art. For example, within 1%, 2%, 3%, 5%, and 10% of what is specified herein.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

What is claimed is:

1. A high-performance descent method for a multi-rotor aircraft, the high-performance descent method comprising:
preparing the multi-rotor aircraft for a high-performance descent;
instructing, via a flight control system, a first proprotor to tilt;
tilting the proprotor away from a vertical axis; and
wherein, responsive to the tilting, an altitude of the multi-rotor aircraft is reduced.

2. The high-performance descent method of claim 1, wherein the preparing the multi-rotor aircraft comprises setting a speed of the first proprotor to its minimum operating speed.

3. The high-performance descent method of claim 1, wherein the multi-rotor aircraft comprises the first proprotor, a second proprotor, a third proprotor, and a fourth proprotor.

4. The high-performance descent method of claim 3, wherein the tilting the proprotor comprises:
tilting the first and second proprotors toward the third and fourth proprotors; and
tilting the third and fourth proprotors toward the first and second proprotors.

5. The high-performance descent method of claim 3, wherein the tilting the proprotor comprises:
tilting the first and second proprotors toward the third and fourth proprotors; and
tilting the third and fourth proprotors away from the first and second proprotors.

6. The high-performance descent method of claim 3, wherein the tilting the proprotor comprises tilting the first and second proprotors away from the third and fourth proprotors.

7. The high-performance descent method of claim 3, wherein the tilting the proprotor comprises tilting the first, second, third, and fourth proprotors away from each other.

8. The high-performance descent method of claim 3, wherein the tilting the proprotor comprises tilting the first, second, third, and fourth proprotors toward a common focal point.

9. The high-performance descent method of claim 3, wherein the tilting the proprotor comprises tilting the first, second, third, and fourth proprotors in the same direction.

10. The high-performance descent method of claim 1, wherein thrust generated by the multi-rotor aircraft is horizontally unbalanced.

11. The high-performance descent method of claim 1, wherein thrust generated by the multi-rotor aircraft is horizontally balanced.

12. The high-performance descent method of claim 3, wherein, during landing, thrust from the first, second, third, and fourth proprotors is vectored away from a vertical axis to reduce an up-spout effect to improve landing stability.

13. A high-performance descent system for a multi-rotor aircraft, the system comprising:
a flight control computer comprising a processor;
a propulsion system communicatively coupled to the flight control computer and configured to allow a direction of thrust relative to a vertical z-axis to be selected by the flight control computer;
wherein the processor is operable to implement a method comprising:
preparing the multi-rotor aircraft for a high-performance descent;
instructing, via a flight control system, a first proprotor to reduce an amount of vertical thrust produced by the proprotor by tilting the proprotor away from a vertical axis; and
reducing an altitude of the multi-rotor aircraft.

14. The high-performance descent system of claim 13, wherein the multi-rotor aircraft comprises the first proprotor, a second proprotor, a third proprotor, and a fourth proprotor.

15. The high-performance descent system of claim 14, wherein the tilting the proprotor comprises:
tilting the first and second proprotors toward the third and fourth proprotors; and
tilting the third and fourth proprotors toward the first and second proprotors.

16. The high-performance descent system of claim 14, wherein the tilting the proprotor comprises:
tilting the first and second proprotors toward the third and fourth proprotors; and
tilting the third and fourth proprotors away from the first and second proprotors.

17. The high-performance descent system of claim 14, wherein the tilting the proprotor comprises tilting the first and second proprotors away from the third and fourth proprotors.

18. The high-performance descent system of claim 14, wherein the tilting the proprotor comprises tilting the first, second, third, and fourth proprotors away from each other.

19. The high-performance descent system of claim 14, wherein the tilting the proprotor comprises tilting the first, second, third, and fourth proprotors toward a common focal point.

20. The high-performance descent system of claim 14, wherein the tilting the proprotor comprises tilting the first, second, third, and fourth proprotors in the same direction.
